(19) United States
(12) Patent Application Publication
(10) Pub. No.: US 2001/0038790 A1
(43) Pub. Date: Nov. 8, 2001

(54) Bale handling apparatus

(76) Inventor: Eldon E. Evans, Glendive, MT (US)

Correspondence Address: Richard C. Conover, P.O. Box 1329, Bozeman, MT, 59771-1329, US

(21) Appl. No.: 09/811,130

(22) Filed: Mar. 14, 2001

Related U.S. Application Data
(60) Provisional application No. 60/189,628, filed on Mar. 14, 2000.

(51) Int. Cl. B66C 1/00

(52) U.S. Cl. 414/740

(57) ABSTRACT

A bale handling apparatus attached to lifting arms of a tractor with a front-end loader having an axle removeably attached to the lifting arms and extending in a generally horizontal, forward direction. A support column is rotatably secured to the axle. A lower fixed jaw has one end fixedly secured to the support column and has an opposite end extending in a forward direction. An upper moveable jaw is also provided having one end extending in a forward direction, and has an opposite end hingedly secured to the support column at a position spaced apart from the fixed jaw. The lower jaw and upper jaw are positioned to face one another. Hydraulic means is provided for closing the upper jaw toward the lower jaw for gripping a round bale between the jaws and hydraulic means is provided for rotating the lower jaw and the upper jaw together about the axle.

### BACKGROUND OF INVENTION

This invention relates to an apparatus for handling a round hay bale which can be used to pick up a round bale and rotate it by approximately 90 degrees. The device is adapted to be mounted to a front-end loader of a tractor and is used to stack round hay bales, weighing several hundreds of pounds, on end.

Several round hay bale lifters have been described previously in the literature. For instance, see U.S. Pat. No. 5,150,999 to Dugan and Great Britain Patent No. 2,204,557 to Pratt which describe mechanisms for handling round hay bales. Both of these patents show tines for lifting the bales and are only capable of limited rotation. The tines provide positive control over a hay bale as long as a tractor is moving in a direction toward a bale speared onto a tine. However, if the tractor is moving backward away from a bale so speared, any touching of the bale to other parts of a haystack while the hay bale is being maneuvered for stacking has the detrimental effect of backing the hay bale off of the tine at an inappropriate time.

From the above, it can be seen that what is needed is a device which can pick up a heavy round bale of hay, rotate the bale so that its longitudinal axis is approximately vertical, and then be able to set the hay bale down on a stack made up of a number of other, similarly-oriented bales. To accomplish this task, positive control over a hay bale is needed so that, no matter whether a tractor is moving toward a bale or backing away from a bale in the close confines near a haystack, positive control is maintained at all times over the heavy hay bale.

### SUMMARY OF INVENTION

A hay bale manipulating device of the present invention is removeably attached to a front-end loader of a conventional tractor. This device includes a bridge plate extending between the lifting arms of the front-end loader. An axle is affixed to the bridge plate and extends in a forward direction. A sleeve rotatably receives the axle. A support plate is fixedly secured to the sleeve in such a manner that the support plate rotates in a plane oriented substantially parallel with the bridge plate.

A pair of spaced apart, upright columns are welded to the support plate on opposite sides of the sleeve. An upper moveable jaw, extending in a forward direction, is hingedly connected to the columns about a horizontal axis running parallel to the bridge plate. The moveable jaw may be lifted or lowered about the horizontal axis. Further, the moveable jaw is manipulated by a pair of hydraulic cylinders which are activated by the person driving the tractor.

A lower fixed jaw is fixedly connected to the support plate and also extends in a forward direction. Both the moveable jaw and the fixed jaw are shaped so as to cooperatively grip a round hay bale between the two jaws.

A hydraulic cylinder is also provided for rotating the support plate, together with the upper and lower jaws, relative to the bridge plate about the axle attached to the bridge plate. This hydraulic cylinder is activated by the person driving the tractor.

### DESCRIPTION OF THE DRAWINGS

In order that the invention may be clearly understood and readily carried into effect, a preferred embodiment of the invention will now be described, by way of example only, with reference to the accompanying drawings wherein:

FIG. 1 is a side elevational view of the present invention mounted to a front-end loader of a tractor;

FIG. 2 is a front elevational view of the present invention shown in FIG. 1;

FIG. 3 is a front elevational view of the present invention similar to that shown in FIG. 2, but with the bale gripping jaws rotated approximately 90 degrees; and

FIG. 4 is a cross-sectional view along the line 4-4 in FIG. 2.

### DESCRIPTION OF A PREFERRED EMBODIMENT

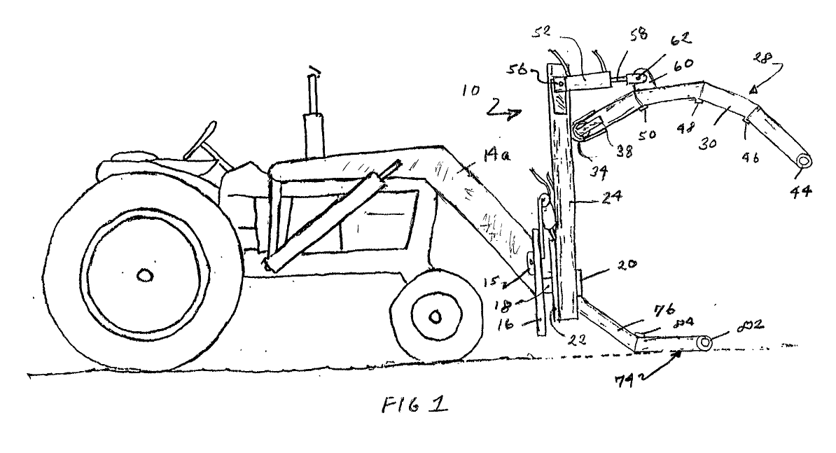

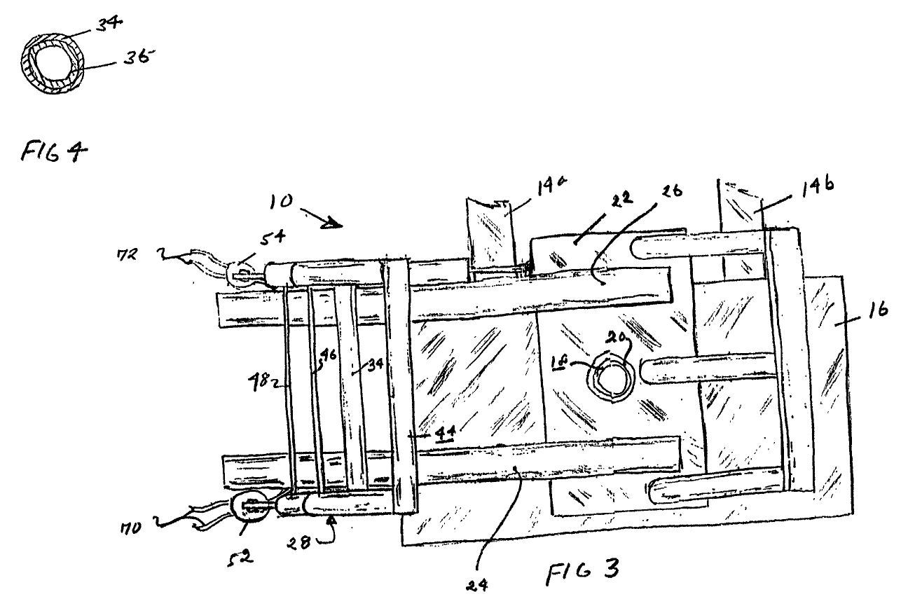

A preferred embodiment of a bale handling apparatus 10 is shown in FIGS. 1-3. The apparatus 10 is removeably connected to a pair of lifting arms 14a and 14b associated with a tractor having a front-end loader, as shown in FIGS. 1 and 3.

Apparatus 10 includes a bridge plate 16 which extends between and beyond the lifting arms 14a and 14b as best seen in FIG. 3. Bridge plate 16 is removeably attached to each lifting arm using conventional attachment pins and conventional mounting brackets 15, as shown in FIG. 1.

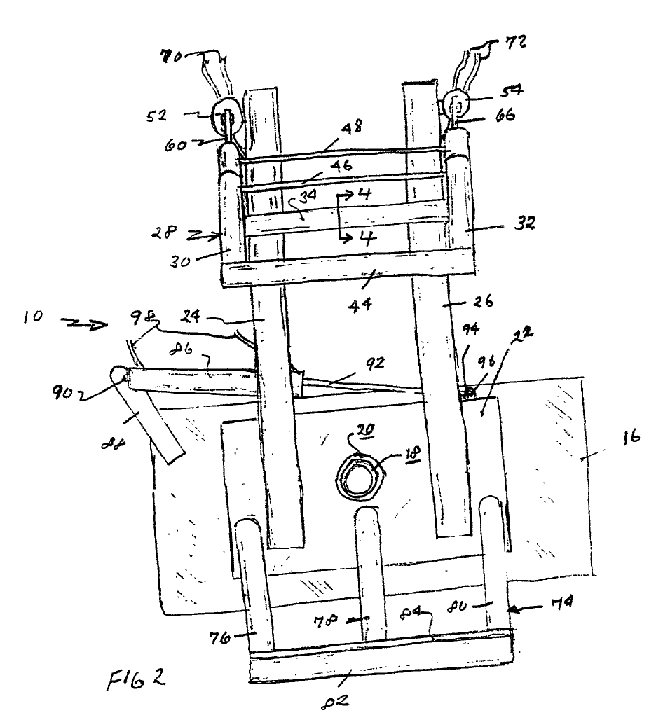

An axle 18 is fixedly attached to, and extends forward and away from, bridge plate 16 as shown in FIGS. 1 and 2. A sleeve 20 rotatably receives axle 18 and acts as a bearing. A support plate 22 is fixedly secured to sleeve 20 in such a manner that the support plate is oriented substantially parallel with bridge plate 16. With this mechanical arrangement, support plate 22 can thus rotate relative to, but remain substantially parallel with, bridge plate 16.

A pair of spaced apart upright columns 24 and 26 are welded to support plate 22 on opposite sides of sleeve 20, as shown in FIG. 2.

A tubular sleeve 34 spans between columns 24 and 26 adjacent the upper ends thereof as is attached to both columns as by welding, as shown in FIG. 2. An axle 36 is positioned within sleeve 34 as shown in FIG. 4. The axle also spans between columns 24 and 26, and has its ends extending slightly beyond the ends of sleeve 34.

An upper bale engaging jaw 28 includes two long parallel segmented arms 30 and 32. In a preferred embodiment, the arms 30 and 32 are of similar shape, and include four straight segments angularly related to each other to form an arcuate shape, as shown in FIG. 1. It should be understood, however, that other shaped arms could be used equally as well. A cross-brace 44 spans between the spaced apart ends of arms 32 and 34, and are connected to the ends as by welding. Three bracing rods 46, 48 and 50 span the distance between arms 30 and 32, and are connected to the respective arms at the terminal ends of each segment of the arms 30 and 32, as shown in FIGS. 1 and 2.

The arm 30 has a plate 38 welded to arm 30 at one end thereof, which plate 38 is welded to an end of axle 36 extending beyond sleeve 34 as shown in FIG. 1. Similarly, arm 32 has a plate (not shown) welded to arm 32 at one end thereof which plate is welded to the opposite end of axle 36 extending beyond sleeve 34.

A pair of hydraulic cylinders 52 and 54 are provided to move the upper jaw about axle 36. The body of hydraulic cylinder 52 is rotatably pinned to column 24 with pin 56, as shown in FIG. 1. The body of hydraulic cylinder 54 is similarly pinned to column 26. A hydraulically actuated piston 58 of hydraulic cylinder 52 is hingedly connected to a connecting plate 60, which in turn is secured to the arm 30 as shown in FIG. 1, with pin 62. Similarly, a hydraulically actuated piston 64 of hydraulic cylinder 54 is pivotally connected to connecting plate 66 with a pin (not shown). The hydraulic pistons of hydraulic cylinders 52 and 54 are connected to the arms 30 and 32, at a position spaced apart from axle 36, so as to provide leverage whenever the hydraulic cylinders are used to move the upper jaw 28. Hydraulic cylinders 52 and 54 have attached hydraulic hoses 70 and 72 respectively, which connect the hydraulic cylinders to a hydraulic pump located on the tractor, and further to a hydraulic control lever located adjacent the tractor driver, all in a conventional manner.

A lower fixed jaw 74 includes three (3) parallel segmented arms 76, 78 and 80, as shown in FIG. 2. Each of the arms 76, 78 and 80 have one end attached to the support plate 22, as by welding. In a preferred embodiment, the segmented arms 76, 78 and 80 each include two segments, although other shaped jaw arms could be used equally as well. At the distal end of arms 76, 78 and 80, a cross-brace 82 is provided which is attached to the arms, as by welding. Further, a brace rod 84 spans the three arms and is attached thereto as by welding in parallel relation to cross-brace 82.

The support plate 22 may be rotated on axle 18 with hydraulic cylinder 86. The body of the hydraulic cylinder 86 is pinned to a connecting plate 88 with pin 90. Connecting plate 88 is welded to bridge plate 16, as shown in FIG. 2. A hydraulically actuated piston 92 is hingedly connected to connecting plate 94 with pin 96, as seen in FIG. 2. The connecting plate 94 is welded to support plate 22 at a position beyond the axle 18, as shown in FIG. 2. Thus, whenever hydraulic cylinder 86 contracts, it will rotate support plate 22 about the axle 18 in a counterclockwise direction, as shown in FIGS. 2 and 3.

Hydraulic hoses 98 connect hydraulic cylinder 86 to the hydraulic pump of the tractor as well as a hydraulic control lever located adjacent the tractor driver, in a conventional manner.

In operation, the arms 14a and 14b of the front-end loader are lowered so that the lower jaw 74 rests on the ground beside a round bale. The tractor is then driven forward to force the lower jaw underneath the bale. The previously opened upper jaw is then lowered, using the appropriate hydraulic actuating levers so as to grip the round hay bale between the lower fixed jaw and upper moveable jaw. The hydraulic system for the front-end loader lifting arms 14a and 14b is then actuated to raise the arms 14a and 14b. The tractor can then be driven to a place where bales are to be stacked with the round hay bale gripped by the jaws. When it is desired to rotate the bale on end, the hydraulic cylinder 86 is actuated to rotate the support plate 22 to which the jaws 28 and 74 are connected to a position, as shown in FIG. 3. The hydraulic system for the lifting arms 14a and 14b is then actuated appropriately to stack the round bale, on end, at the appropriate place. When this is accomplished, the hydraulic cylinders 52 and 54 are actuated to release the round bale from the jaws, and the tractor moved in a reverse direction. The hydraulic cylinder 86 can then be actuated to extend the hydraulic piston 92 so that the jaws are then oriented in a position to pick up another round bale.

While the fundamental novel features of the invention have been shown and described, it should be understood that various substitutions, modifications and variations may be made by those skilled in the art without departing from the spirit or scope of the invention. Accordingly, all such modifications or variations are included in the scope of the invention as defined by the following claims:

I claim:

1. Bale handling apparatus attached to lifting arms of a tractor with a front-end loader comprising:
an axle removeably attached to the lifting arms and extending in a generally horizontal, forward direction;
a support column rotatably secured to the axle;
a lower fixed jaw having one end fixedly secured to the support column and having an opposite end extending in a forward direction;
an upper moveable jaw having one end extending in a forward direction;
hinge means for hingedly securing an opposite end of the upper jaw to the support column at a position spaced apart from the fixed jaw;
the lower jaw and upper jaw positioned to face one another;
the hinge means positioned to allow the upper jaw to close toward the lower jaw and open away from the lower jaw;
means for hingedly moving the upper jaw relative to the column; and
means for rotating the support column about the axle.

2. The apparatus according to claim 1 wherein the means for hingedly moving the upper jaw includes operator controllable hydraulic means.

3. The apparatus according to claim 1 wherein the means for rotating the support column about the axle include operator controllable hydraulic means.

4. The apparatus according to claim 1 wherein the upper jaw includes a pair of elongate arms constructed of straight segments, the straight segments being angularly joined to form an arm having an arcuate shape opening toward the lower jaw.

5. The apparatus according to claim 1 wherein the lower jaw includes a pair of arms constructed of straight segments, the segments being angularly joined to form an arcuate arm opening toward the upper jaw.
